(19) United States
(12) Patent Application Publication
(10) Pub. No.: US 2006/0060148 A1
(43) Pub. Date: Mar. 23, 2006

(54) Boss buck 4 way unit

(76) Inventor: Thomas M. Boyer, Garland, TX (US)

Correspondence Address: TOM BOYER, 210 S HWY 175, SEAGOVILLE, TX, 75159, US

(21) Appl. No.: 11/097,907

(22) Filed: May 9, 2005

Related U.S. Application Data
(60) Provisional application No. 60/607,426, filed on Sep. 7, 2004.

(51) Int. Cl. A01K 5/00

(52) U.S. Cl. 119/57.91

(57) ABSTRACT

The Boss Buck 4 Way gravity feeder splitter is manufactured with Linear Low Density Polyethylene Plastic with a uv inhibitor. The density factor of the material is 0.935. The manufacturing process is called Rotational Molding. There are two threaded inserts and our graphics logo molded into each unit. Como is the color of plastic we use to create our unique look.

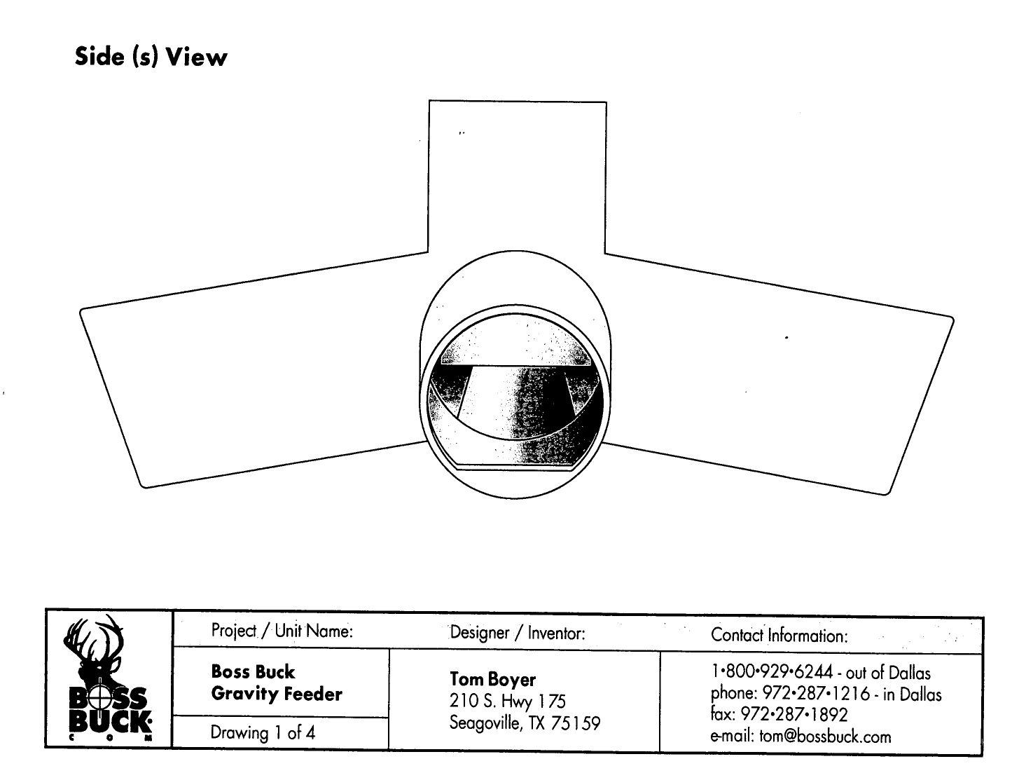

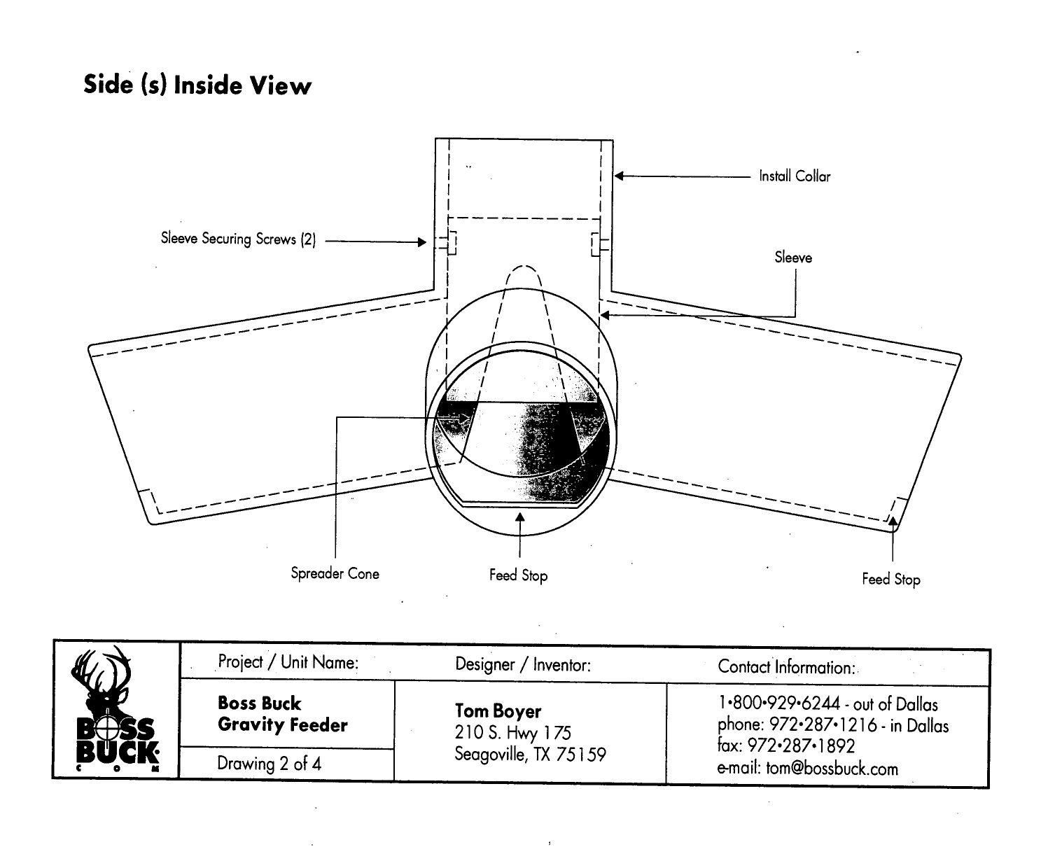

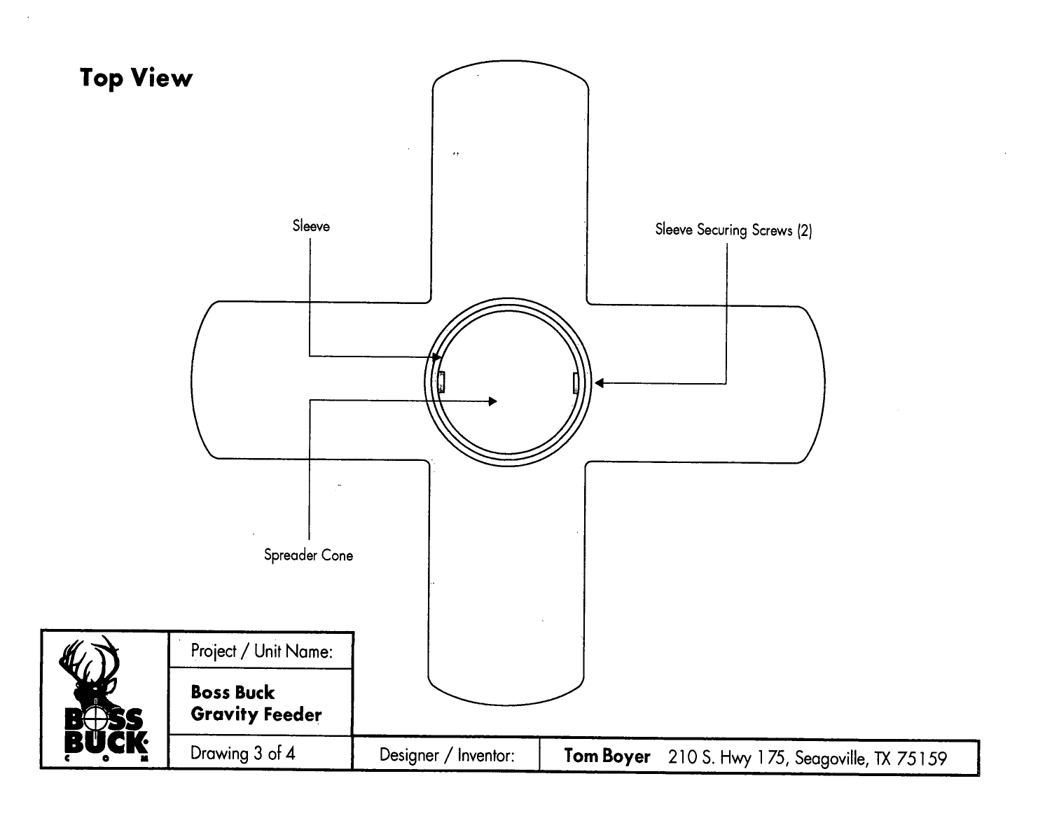

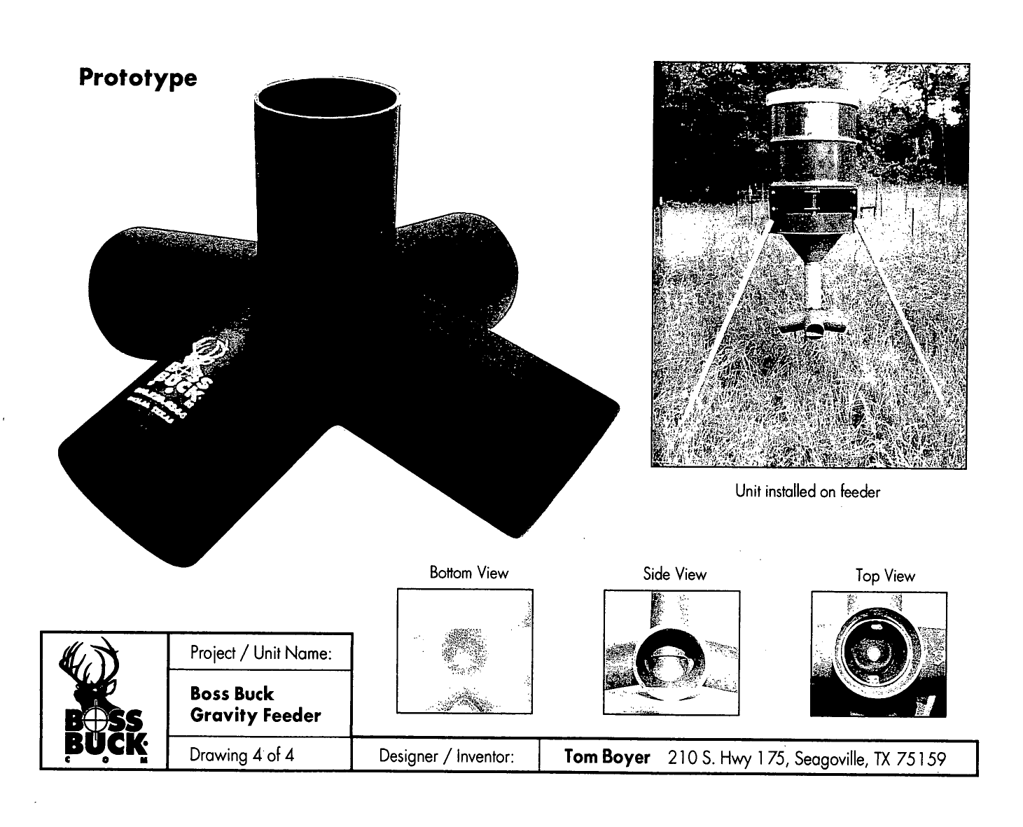

Several features make it unique.
1. Material—The unit is the only plastic unit on the market. The plastic is UV protected for outdoor applications. Rounded edges on the feed receptacles prevent wildlife from hurting their muzzle or beak (turkey) when eating from it.
2. Design—The interior cone formed in the center of the unit is the only one on the market. The cone automatically distributes feed to the feed ports. The feed ports are made with a 10° angle of pitch to make full use of gravity. The inner sleeve that also holds the threaded fittings, slows the feed down so that it won't pour through the lower unit.

Each feeding tube is 5 inches in diameter. The end of each tube has a 1″ “feed dam” to stop feed from pouring out of the unit. Each feed tube also has a drain hole on the bottom of the tube. This allows any moisture that enters the tube to escape. Thus not clogging the tube from dispensing feed like other gravity feeders on the market.

Another feature to prevent moisture is a one inch over hang. Each feed tube is designed so that water cannot drip from the top lip of the tube into the bottom area where the feed is located.

The truly unique part of the system is that there are no “flat or “dead” spots in the inner chamber of the unit. Feed is pulled by gravity to the mouth of the tube without ever stopping inside where an animal can not access the feed. The Boss Buck system forces the feed to the end of the port using gravity. Animals that feed from the ports automatically keep it from clogging, thus stopping the free choice feeding system from working.

Our system, unlike the other types on the market, can be easily removed from the feeder unit. Simply unscrew the two bolts on the sides and pull down on the Four Way Unit. This allows the unit to be placed in a dishwasher to be sanitized, or just to free any obstruction that sometimes come in bagged feed from a mill.

This is what makes the Boss Buck Four Way gravity feeder unit different from all other gravity feeder units on the market today.

1- Material—The unit is the only plastic unit on the market. The plastic is UV protected for outdoor applications. Rounded edges on the feed receptacles prevent wildlife from hurting their muzzle or beak (turkey) when eating from it.

2- Design—The interior cone formed in the center of the unit is the only one on the market. The cone automatically distributes feed to the feed ports. The feed ports are made with a 10° angle of pitch to make full use of gravity. The inner sleeve that also holds the threaded fittings, slows the feed down so that it won't pour through the lower unit.

3- Each feeding tube is 5 inches in diameter. The end of each tube has a 1″ “feed dam” to stop feed from pouring out of the unit. Each feed tube also has a drain hole on the bottom of the tube. This allows any moisture that enters the tube to escape. Thus not clogging the tube from dispensing feed like other gravity feeders on the market.

4- Another feature to prevent moisture is a one inch over hang. Each feed tube is designed so that water cannot drip from the top lip of the tube into the bottom area where the feed is located.

5- The truly unique part of the system is that there are no “flat or “dead” spots in the inner chamber of the unit. Feed is pulled by gravity to the mouth of the tube without ever stopping inside where an animal can not access the feed. The Boss Buck system forces the feed to the end of the port using gravity. Animals that feed from the ports automatically keep it from clogging, thus stopping the free choice feeding system from working.

6- Our system, unlike the other types on the market, can be easily removed from the feeder unit. Simply unscrew the two bolts on the sides and pull down on the Four Way Unit. This allows the unit to be placed in a dishwasher to be sanitized, or just to free any obstruction that sometimes come in bagged feed from a mill. This is what makes the Boss Buck Four Way gravity feeder unit different from all other gravity feeder units on the market today.
